(19) United States
(12) Patent Application Publication
(10) Pub. No.: US 2022/0136176 A1
(43) Pub. Date: May 5, 2022

(54) Platelike thermal insulation material made from recycled and environmentally friendly raw materials

(71) Applicant: BALTICFLOC, SIA, Césis (LV)

(72) Inventor: Edzus Cabulis, Priekuli (LV)

(21) Appl. No.: 17/436,087

(22) PCT Filed: May 3, 2019
(86) PCT No.: PCT/IB2019/053646

§ 371 Date: Sep. 3, 2021

(51) Int. Cl. D21J 1/20; D21H 11/12; D21H 11/14; D21H 17/00; D21H 17/67; D21H 17/64; D21H 17/65; D21H 21/14; E04B 1/80

(52) U.S. Cl. CPC D21J 1/20; D21H 11/12; D21H 11/14; D21H 17/73; E04B 2001/745; D21H 17/64; D21H 17/65; D21H 21/143; E04B 1/80; D21H 17/67

(57) ABSTRACT

The present invention relates to thermal insulation materials, particularly to environmentally friendly thermal insulation materials, manufacturing of which involves recycled raw materials and hemp fibres. The thermal insulation material described in the invention further comprises bi-component binder and conservation additive.

### TECHNICAL FIELD

The present invention relates to thermal insulation materials, particularly to environmentally friendly thermal insulation materials, manufacturing of which involves recycled raw materials and hemp fibres.

### BACKGROUND ART

Many and various thermal insulation materials with different thermal and sound insulation properties are known, however nowadays increased attention is pointed towards how ecological is the material, namely, is the material friendly to the environment and human health during its production, use and after it has been utilised. Heat effectiveness and application of hemp in heating of building constructions are known for ages. Also in LT6210 hemp is named as applicable component in thermal insulation material, which protects composite with thermal insulation properties that contains 45 to 67% filler of hemp shives and 10 to 20% cellulose. Presence of cellulose and hemp derived raw material is named, without disclosing precise percentage of content and ratio, in EP1718896, which in manufacturing of product uses hemp fibres as ingredient of product, also mentioning bi-component polymer fibres.

An object of the invention is to create a thermal insulation material made from recycled and environmentally friendly raw materials, composition of which would increase protection of the product both against microbiological pollution and against rodents.

### DETAILED DESCRIPTION OF THE INVENTION

The object of the invention is achieved by creation of product that is applicable as thermal insulation material and which comprises recycled raw materials, mainly, wastepaper, hemp fibres, bi-component binder, as well as additive.

Facilitating waste management and significantly reducing the consumption of natural resources, crushed wastepaper, which often is not recycled and arrives in landfills or is burned, more precisely glossy paper, magazines, laminated paper, books, cardboard, napkins, packaging, such as paper coffee cups, Tetra Pak, egg cartons, as well as plastic, particularly polyethylene, and iron, aluminium particles, are used as recycled raw material. Mentioned waste is treated, repeatedly crushed and separated from inapplicable admixtures. The length of fibres of the recycled raw material is 2 to 6 mm. The recycled raw material comprises 50% of the total weight of the material.

Hemp fibres that are also crushed resulting in 3 to 10 mm fibres comprise 20% of the total weight of the material. Characteristic thermal conductivity of hemp fibres is 0.036 W/mK.

To achieve the object of the invention a product in a form of a plate in thickness of 50 to 250 mm is created. To bind raw materials into one plate, bi-component binder is added to hemp fibres and recycled raw material, wherein bi-component binder comprises 24.5 to 26.5% of the total weight of the material. Bi-component binder consists of polyester fibre core and a sheath of ethylene/vinyl acetate copolymer or other organic copolymer of ethylene with polar comonomer, especially acrylate(s) and melts in temperature of 100° C. The length of the bi-component binder fibres is 6 to 40 mm.

An additive that comprises sulphamidic acid, aluminium hydroxide and silver in amount of 3.5 to 5.5% of the total weight of the material is added to the plate composition. The presence of such a binder in a thermal insulation material improves its reaction to fire class, as well as improves protection of the product both against microbiological pollution and against rodents it prevents the formation of mold and fungus, as well as does not attract rodents.

The described plates are ecological and their manufacture does not pollute the environment and does not involve usage of non-renewable natural resources.

The material gained as a result of the present invention is characterized by thermal conductivity in a range of 0.036 to 0.040 W/mK.

### BRIEF DESCRIPTION OF THE ACCOMPANYING DRAWINGS

FIG. 1 illustrates sectional view of the thermal insulation material.

### EXAMPLES FOR WORKING OF THE INVENTION

### Example 1

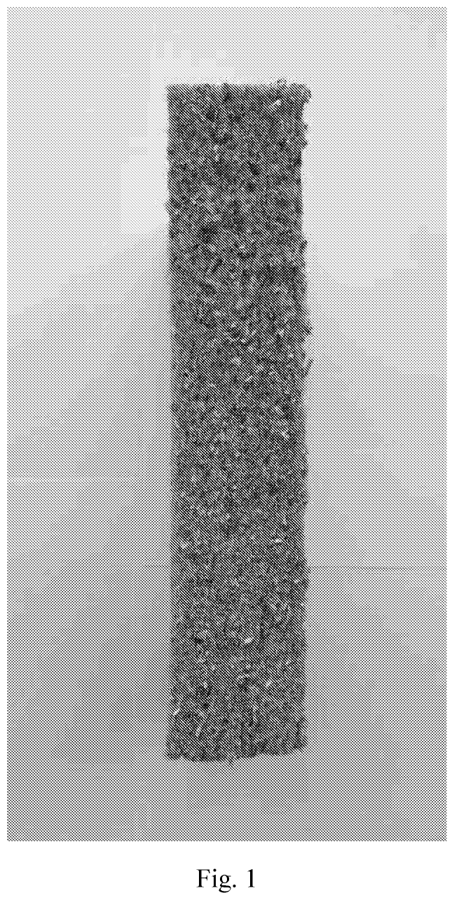

FIG. 1 illustrates a thermal insulation material plate in thickness of 150 mm, which comprises 50% of recycled raw material obtained from crushed glossy paper, magazines, laminated paper, books, cardboard, napkins, paper coffee cups, Tetra Pak, egg cartons, polyethylene, iron and aluminium folium, the length of fibres of which variates from 2 to 6 mm; 20% of hemp fibres, the length of fibres of which variates from 3 to 10 mm, 25% of bi-component binder consisting of polyester fibre core and a sheath of ethylene/vinyl acetate copolymer, the length of fibres of which variates from 6 to 40 mm and 5% of preservative additive comprising sulphamidic acid, aluminium hydroxide and silver. The thermal conductivity of the insulation material is 0.038 W/mK.

### Example 2

The working of the invention is possible also as a thermal insulation material plate in thickness of 50 to 250 mm, which comprises 50% of recycled raw material obtained from crushed wastepaper, glossy paper, magazines, laminated paper, books, cardboard, napkins, packaging, paper coffee cups, Tetra Pak, egg cartons, plastic, polyethylene, iron and aluminium folium, the length of fibres of which variates from 3 to 5 mm; 20% of hemp fibres, the length of fibres of which variates from 5 to 8 mm, 26% of bi-component binder consisting of polyester fibre core and a sheath of ethylene/vinyl acetate copolymer, the length of fibres of which variates from 10 to 30 mm and 4% of preservative additive comprising sulphamidic acid, aluminium hydroxide and silver. The thermal conductivity of the insulation material is 0.036 to 0,040 W/mK.

### Example 3

Another example of working of the invention is a thermal insulation material plate in thickness of 50 to 250 mm, which comprises 50% of recycled raw material obtained from crushed wastepaper, glossy paper, magazines, laminated paper, books, cardboard, napkins, packaging, paper coffee cups, Tetra Pak, egg cartons, plastic, polyethylene, iron and aluminium folium, the length of fibres of which variates from 4 to 5 mm; 20% of hemp fibres, the length of fibres of which variates from 6 to 7 mm, 24.5% of bi-component binder consisting of polyester fibre core and a sheath of ethylene/vinyl acetate copolymer, the length of fibres of which variates from 20 to 25 mm and 5.5% of preservative additive comprising sulphamidic acid, aluminium hydroxide and silver. The thermal conductivity of the insulation material is 0.036 to 0,040 W/mK.

1. A thermal insulation material comprising crushed recycled raw material, hemp fibres and a bi-component binder, wherein the thermal insulation material additionally containing a preservation additive that comprises sulphamidic acid, aluminium hydroxide and silver and wherein the crushed recycled raw material is crushed wastepaper, glossy paper, magazines, laminated paper, books, cardboard, napkins, packaging, paper coffee cups, egg cartons, as well as plastic, particularly polyethylene, and iron, aluminium particles, wherein the crushed recycled raw material comprises 50% of the total weight of the thermal insulation material, hemp fibres comprise 20% of the total weight of the thermal insulation material, the bi-component binder comprises 24.5 to 26.5% of the total weight of the thermal insulation material and the preservation additive comprises 3.5 to 5.5% of the total weight of the thermal insulation material, and wherein the length of hemp fibres is 3 to 10 mm.

2. The thermal insulation material according to claim 1, wherein the length of fibres of the crushed recycled raw material is 2 to 6 mm.

3. The thermal insulation material according to claim 1, wherein the bi-component binder consists of a polyester fibre core and a sheath of ethylene/vinyl acetate copolymer or other organic copolymer of ethylene with polar comonomer, especially acrylate(s).

4. (canceled)

5. The thermal insulation material according to claim 1, wherein the length of the bi-component binder fibres is 6 to 40 mm.

6. (canceled)

7. The thermal insulation material according to claim 1, wherein the thermal insulation material is in a form of plate in thickness of 50 to 250 mm.

8. The thermal insulation material according to claim 1, wherein thermal conductivity in a range of 0.036 to 0.040 W/mK.
